(19) United States
(12) Patent Application Publication
(10) Pub. No.: US 2007/0287047 A1
(43) Pub. Date: Dec. 13, 2007

(54) Device For Carrying Out A Chemical Reaction

(75) Inventors: Wolfram Kaiser, Stuttgart (DE); Conrad Pfender, Besigheim (DE)

Correspondence Address: FOLEY AND LARDNER LLP;SUITE 500, 3000 K STREET NW, WASHINGTON, DC, 20007, US

(73) Assignee: BEHR GMBH & CO. KG, 70469 Stuttgart (DE)

(21) Appl. No.: 11/667,916

(22) PCT Filed: Nov. 16, 2005
(86) PCT No.: PCT/EP05/12271

§ 371 Date: May 17, 2007

(30) Foreign Application Priority Data
Nov. 18, 2004 (DE) 10 2004 055 777.2
Apr. 22, 2005 (DE) 10 2005 019 022.7
Jul. 4, 2005 (DE) 10 2005 031 476.7

(51) Int. Cl. H01M 8/02; H01M 4/86; H01M 8/04; H01M 8/10

(52) U.S. Cl. 429/26; 29/730

(57) ABSTRACT

The invention relates to a device for carrying out a chemical reaction, particularly for producing electrical energy. The inventive device comprises at least one first flow channel for a first reaction medium, at least a second flow channel for a second reaction medium that is different from the first reaction medium, at least a third flow channel for a first temperature-adjusting medium and at least a fourth flow channel for a second temperature-adjusting medium that is different from the first temperature-adjusting medium.

Device for carrying out a chemical reaction The invention relates to a device for carrying out a chemical reaction comprising flow channels for temperature-adjusting or reaction media. The invention furthermore relates to a plate assembly for forming such a device.

Under certain circumstances, the conversion of chemical energy into electrical energy by means of such devices is an efficient and environmentally friendly method of obtaining electrical current from the operating media hydrogen and oxygen. Conventionally, this involves two spatially separate electrode reactions taking place in which electrons are respectively released or bound. The following reactions are one example of two corresponding electrode reactions in a device of this generic type:
H₂=>2H⁺+2e⁻(anodic reaction)
2 H⁺+2e⁻+½O₂=>H₂O (cathodic reaction)

In another design, the following reactions may for example also be observed:
H₂+O₂₋=>H₂O+2e⁻(anodic reaction I)
CO+O₂₋=>CO₂+2e⁻(anodic reaction II)
O₂+4e⁻=>2O²⁻(cathodic reaction)

Other devices of this generic type sometimes involve other reactions. Common factors in each case are the transport of a species in electrically nonneutral form through an electrolyte and the transport, which proceeds in parallel, of electrons through an external conductor in order to return the species to an electrically neutral state after the transport operation.

A proportion of the reaction enthalpy converted in so doing may be obtained directly as electric current by electrically connecting the spatially separate reaction zones. Conventionally, two or more electrically series-connected reaction units are stacked on one another and a stack formed in this manner is used as a current source. An individual reaction unit here consists of an electrolyte unit, such as a membrane, which separates the reactants, in particular hydrogen and oxygen or hydrogen/carbon monoxide and oxygen, from one another and exhibits ion conductivity, in particular H⁺ proton conductivity or O²⁻ conductivity, together with two electrodes coated with catalyst material, which are inter alia necessary for tapping the electrical current produced by the reaction unit.

The reactants, for example hydrogen and oxygen, and the reaction product water and optionally a medium which serves to dissipate excess heat of reaction, flow through fluid channels, the reactants not necessarily having to be present in pure form. For example, the fluid on the cathode side may be air, the oxygen of which participates in the reaction. In particular when a heat-dissipating medium is used, thermal connection of the respective fluid channels ensures sufficient heat transfer between the respective fluids.

For the purposes of the present invention, reactants and reaction products are designated reaction media. A temperature-adjusting medium is a medium which is suitable for supplying heat to or dissipating heat away from a device or a reaction zone.

The waste heat generated in a device of the generic type is usually dissipated via a cooling medium and a separate cooling circuit and must be released into the surroundings. Since the temperature difference between the device and its surroundings is conventionally lower than in a combustion engine of comparable power, the cooling requirement or cooler is often larger despite the greater efficiency.

A fundamental distinction may be drawn between gas-cooled and liquid-cooled devices for carrying out a chemical reaction. In air-cooled devices, the heat balance is controlled by incorporating suitable cooling channels into individual plates of a plate stack and passing a stream of air through these channels and dissipating the excess waste heat with this stream of air. Liquid-cooled devices, on the other hand, have a liquid cooling medium, which is usually of elevated thermal capacity, passed through them, said medium absorbing the waste heat which arises during the chemical reaction and releasing it into the surroundings in an external cooler which is spatially separate from the device, said cooler in turn usually being air-cooled.

Due to the relatively low thermal capacity of cooling air and the relatively large volumetric flow rates associated therewith, a requirement arises in the case of the air-cooled arrangement for relatively large, straight air cooling channels in order to keep the pressure drop and thus the energy requirement for the cooling air stream within limits. Since the reaction media to be cooled are frequently likewise gaseous and have a specific heat capacity similar to that of the cooling air, air-cooled devices usually exhibit a steep temperature gradient along the cooling air channel. Particularly strong cooling is here in particular provided in the area of the active reaction zone, which is closest to the cooling air inlet, while virtually no heat transfer any longer occurs in areas located close to the cooling air outlet. It has been found that, under certain circumstances, the resultant nonuniform temperature profile has a disadvantageous impact on efficient operation of the device.

The liquid-cooled arrangement is in particular problematic, under certain circumstances, when using polymer materials for the electrolyte membrane due to their susceptibility to contamination with metal ions. If, for example, it is desired to operate a liquid-cooled device in conjunction with a known aluminum heat exchanger, it is necessary, in order to avoid contamination of the polymer membranes, to use a liquid cooling medium which cannot transport any metal ions, for example a heat-transfer oil, or alternatively to use an ion-exchange cartridge to purify the liquid cooling medium. This gives rise to disadvantages in the form of a lower specific heat-transfer capacity (heat-transfer oil) or in the form of additional system complexity (ion-exchange cartridge).

The hydrogen-containing operating gas required in the device is produced, in particular in the case of on-board gas generation in motor vehicles, by making use of liquid fuels (for example gasoline, diesel, methanol, etc.) or gaseous fuels (for example natural gas) as the starting material. Various methods are known for the production of hydrogen-rich gas from these fuels, said methods substantially being based on one or a combination of two or more of the following chemical processes:

a) breaking the fuel down, for example by “thermal cracking”, into its starting materials, optionally over a catalyst. One example is the reaction of octane:
C₈H₁₈→8C+9H₂.

b) partially oxidizing the fuel over a catalyst with addition of (atmospheric) oxygen in a stoichiometric or substoichiometric amount.

Examples are the reactions of octane: C₈H₁₈+8 O₂→8 CO₂+9 H₂ (stoichiometric) or C₈H₁₈+4 O₂→8 CO+9 H₂ (substoichiometric).

c) steam reforming the fuel over a catalyst with addition of water. One example is the reaction of octane: C₈H₁₈+16 H₂O→8 CO₂+25 H₂.

d) autothermal reforming of the fuel by combining partial oxidation and steam reforming in such a manner that the energy balance of the overall reaction is exactly compensated by the combination of the endothermic steam reforming and the exothermic partial oxidation.

Such a process generally proceeds in a “reformer”, complete conversion not being achieved in practice and a greater or lesser proportion of carbon monoxide remaining in the gas which is produced. Using a suitable catalyst, additional hydrogen may subsequently be obtained at the expense of the CO concentration by making use of “shift” stages exploiting the water gas shift reaction (CO+H₂O→CO₂+H₂).

More extensive purification to remove CO from the gas may, if required, be effected by carrying out selective oxidation over a catalyst suitable for this purpose. The remaining carbon monoxide is here oxidized by addition of (atmospheric) oxygen to yield carbon dioxide: 2 CO+O₂→CO₂.

Further purification of the gas to remove sulfur or sulfur compounds may be carried out by passive adsorption (for example onto zeolites) or catalytic transformation of the sulfur compounds present in the fuel or reformate on a suitable catalyst or adsorbent. Desulfurization is in principle possible before reforming (on the liquid or vaporized fuel) or also after reforming (on the reformate). In the latter case, the sulfur compounds remaining in the reformate are reacted with hydrogen, for example by means of the HDS (hydrodesulfurization) process; the resultant H2S is then adsorbed onto a suitable material (for example Cu/Zn pellets) and so removed from the fuel gas.

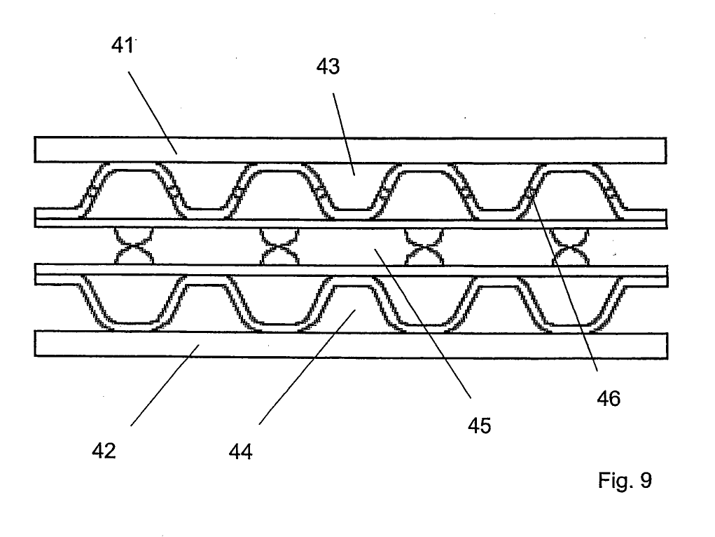

Many or all of these processes conventionally proceed in devices which are in each case specifically designed for the purpose. FIG. 8 provides a schematic overview of the architecture of a fuel cell system.

It is an object of the invention to provide a device for carrying out a chemical reaction which has elevated efficiency combined with relatively low complexity.

This object is achieved by a device for carrying out a chemical reaction which comprises in each case at least one, preferably two or more first flow channels for a first reaction medium, second flow channels for a second reaction medium, third flow channels for a first temperature-adjusting medium and fourth flow channels for a second temperature-adjusting medium.

Thus, according to the invention, at least four media may be conveyed separately from one another. The reaction media serve to supply a chemical reaction zone with the media necessary for the chemical reaction, such as for example hydrogen and atmospheric oxygen, or to remove one or more reaction products. With the assistance of the first temperature-adjusting medium, the waste heat which arises in the device may be dissipated for example directly to the surroundings or the required heat may be supplied directly to the device, in particular with the assistance of a fluid conveying device, such as for example a pump, a fan or the like. Ambient air is preferably used for this purpose as the first temperature-adjusting medium, which air is passed through the device in a suitably large quantity. The second temperature-adjusting medium, for example cooling water, flows in a preferably closed circuit, preferably by means of a suitable fluid conveying device.

Under certain circumstances, lower structural complexity may be achieved with the device according to the invention if additional components such as temperature-adjusting medium lines, pumps or heat exchangers may be dispensed with because the device itself acts as a heat exchanger. In particular, it is possible by the provision of flow channels for different temperature-adjusting media to ensure a more uniform temperature distribution and optionally a steadier output or input of heat, so under certain circumstances enhancing the efficiency of the device. It is advantageous to use two temperature-adjusting media which differ from one another with regard to their thermal capacity and/or their state of matter and/or if the flow channels for the temperature-adjusting media have different shapes and/or cross-sectional areas.

According to a preferred development, the device according to the invention comprises a preferably diffusion-permeable membrane between a first and a second flow channel, such that the reaction media are separated from one another, the chemical reaction being enabled, for example, by ionic diffusion of one or more reactants through the membrane.

According to an alternative development, the flow channels for the reaction media communicate with one another, such that the reactants come directly into contact with one another and, under certain circumstances, may mix with one another. In this way, the chemical reaction is accelerated under certain circumstances, so increasing the efficiency of the device.

The device according to the invention preferably comprises a fifth flow channel for a third temperature-adjusting medium which differs from the first and the second temperature-adjusting media. In this manner, the device may be exposed to three different temperature-adjusting media of a differing function. For example, one temperature-adjusting medium may provide heat dissipation, heat input, vaporization and/or an in particular catalytically assisted reaction of the temperature-adjusting medium itself.

According to a preferred development, at least one flow channel for a reaction medium communicates with a flow channel for a temperature-adjusting medium. In this manner, the flow channel in question for the temperature-adjusting medium may be used as a feed channel for fresh and optionally previously temperature-adjusted reaction medium.

According to an advantageous embodiment, a third or fourth flow channel comprises a catalyst and is particularly preferably catalytically coated. The first or second temperature-adjusting medium then absorbs heat by an endothermic reaction or releases heat by an exothermic reaction, such that, on the one hand, heat dissipation or input is respectively assisted, and, on the other hand, the device optionally performs a further function, namely carrying out the catalyzed reaction, in particular reforming.

The catalyst is preferably arranged on a surface which is thermally decoupled from other flow channels. The catalyzed reaction may thus also proceed at a temperature level which differs from that of the other flow channels. The catalyst is particularly preferably arranged on a plate element which is thermally decoupled from the other flow channels. Thermal decoupling is here in particular effected by projections on the channel wall and/or the plate element, wherein, due to the only point-wise and/or linear contact, heat flow from the channel wall to the plate element or vice versa is then inhibited.

Additionally or alternatively, the respective channel wall and/or the plate element thermally decoupled from the respective channel wall comprises a thermal insulator which in particular takes the form of a surface coating. Under certain circumstances, thermal insulation is also advantageous for flow channels without catalyst.

According to a preferred embodiment, the plate element thermally decoupled from the respective channel wall comprises an in particular catalytically coated honeycomb structure, in particular a honeycomb ceramic, which, by virtue of its starting material, is particularly suitable with regard to thermal decoupling and may be used either with or without using a point-wise arrangement.

According to a further preferred embodiment, the plate element thermally decoupled from the respective channel wall comprises an expanded metal knit fabric or an expanded metal felt, which in a particularly preferred embodiment is connected in electrically conductive manner, for example, by soldering, with one or two channel walls of the flow field.

According to a preferred embodiment, at least one third and/or fourth flow channel communicates with a first and/or second flow channel. In this manner, at least one reaction medium also functions as a temperature-adjusting medium, namely before or after the chemical reaction. This serves, for example, to preheat a reactant, optionally with recovery of reaction waste heat. Particularly preferably, the third or fourth flow channel is provided for this purpose with a catalyst, such that at least one reactant may be prepared in the device according to the invention with a relatively low energy requirement.

Further advantageous embodiments of the invention emerge from the claims and from exemplary embodiments, by means of which the invention is described in greater detail below with reference to the drawings, in which:

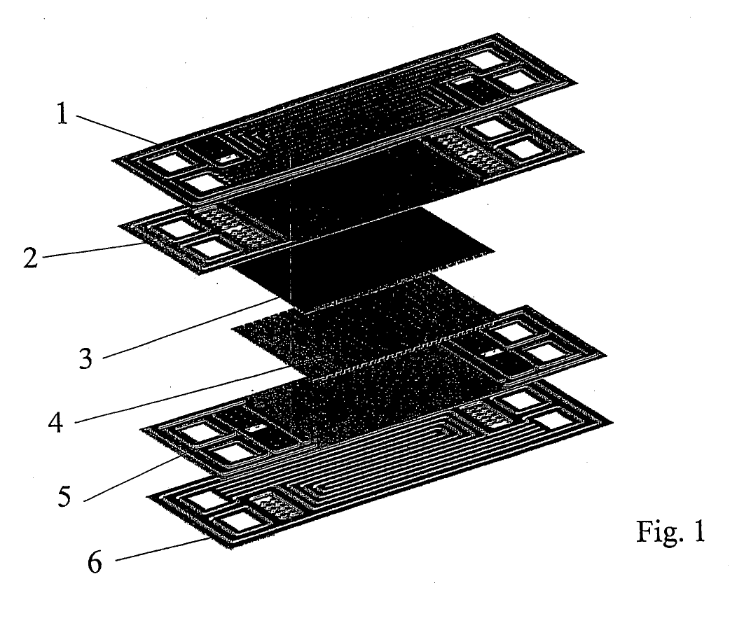

FIG. 1 shows an exploded view of a plate assembly for forming a device according to the invention,

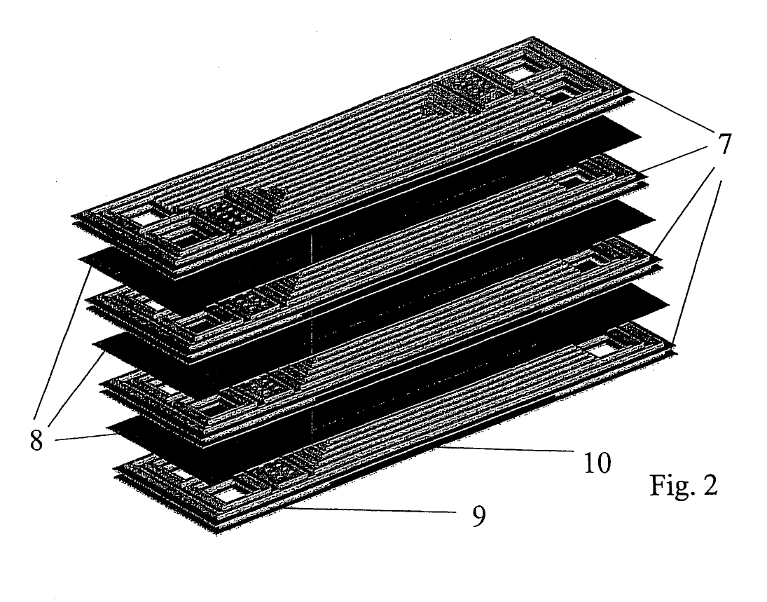

FIG. 2 shows an exploded view of a device for carrying out a chemical reaction,

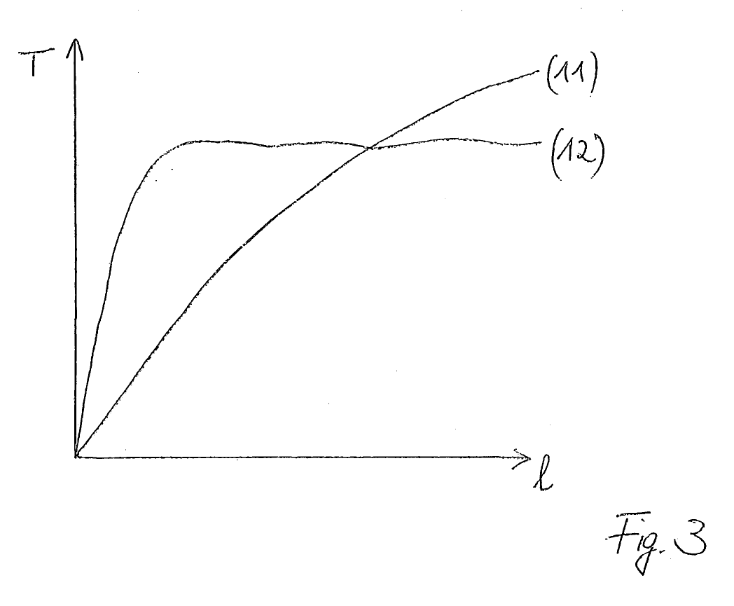

FIG. 3 shows a temperature distribution over devices for carrying out a chemical reaction,

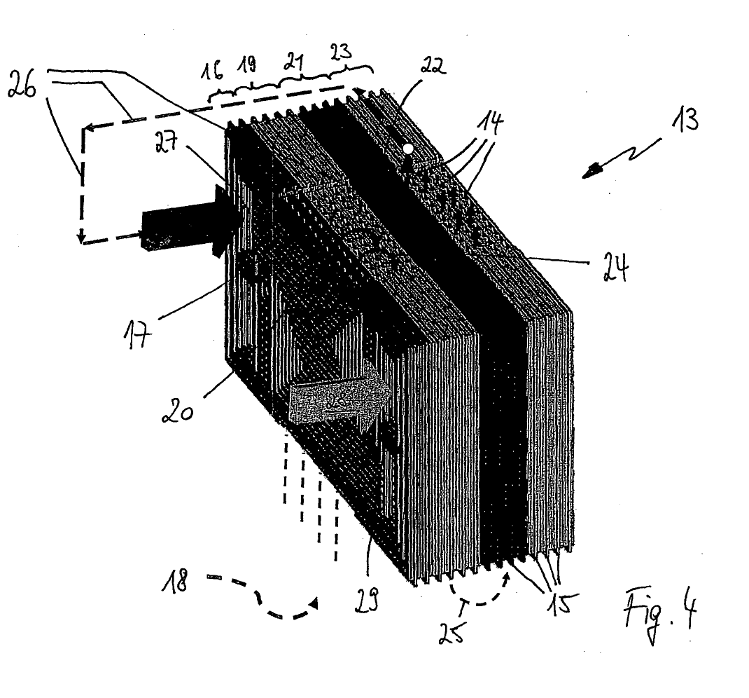

FIG. 4 shows a device for carrying out a chemical reaction,

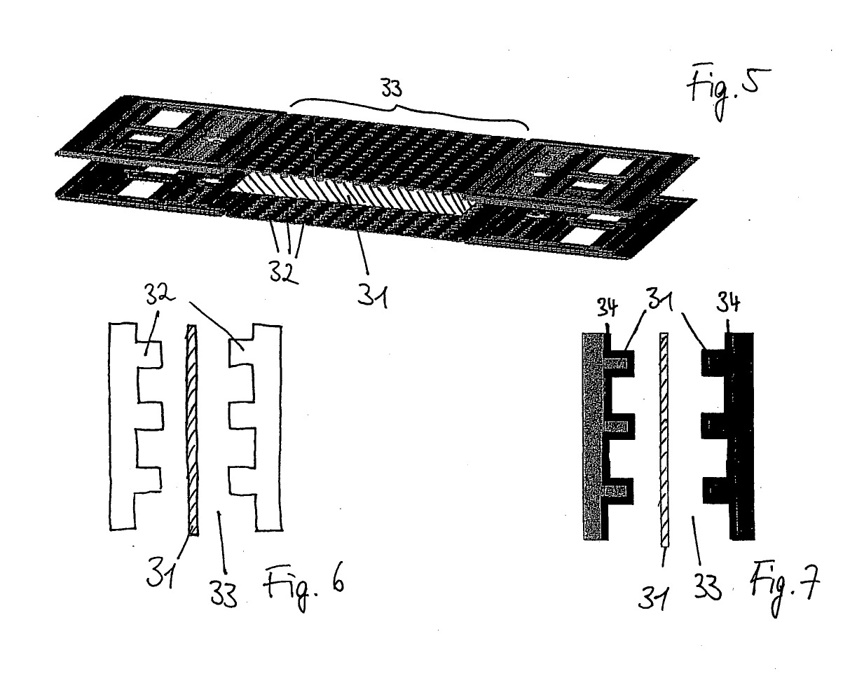

FIG. 5 shows a plate assembly with two plate pairs,

FIG. 6 shows a cross section of a portion of three plates,

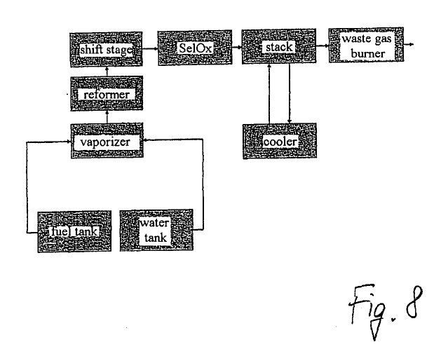

FIG. 7 shows a cross section of a portion of three plates,

FIG. 8 shows a diagram of a fuel cell system,

FIG. 9 shows a cross section of a plate assembly,

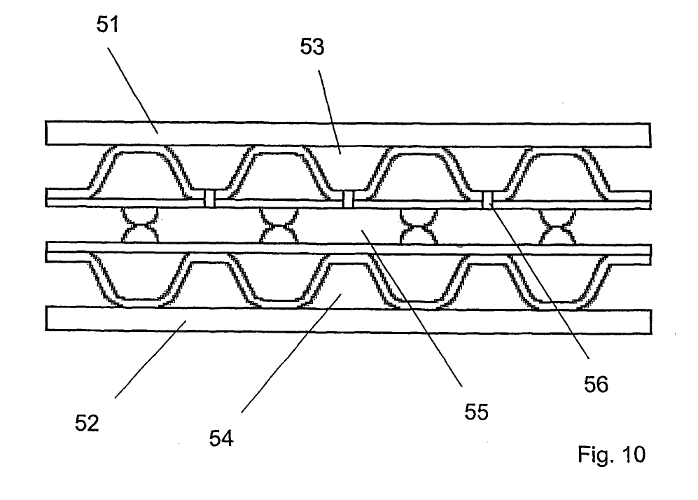

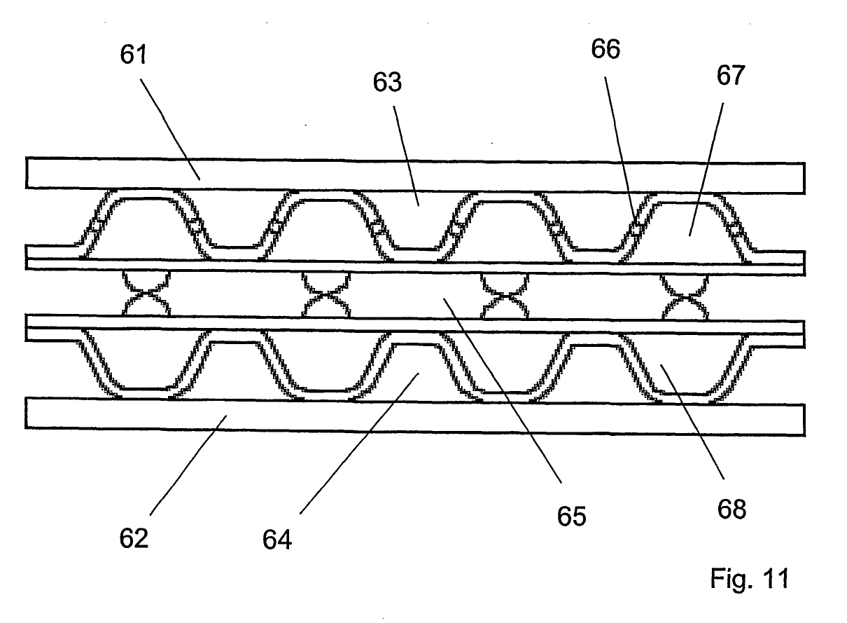

FIG. 10 shows a cross section of a plate assembly,

FIG. 11 shows a cross section of a plate assembly, and

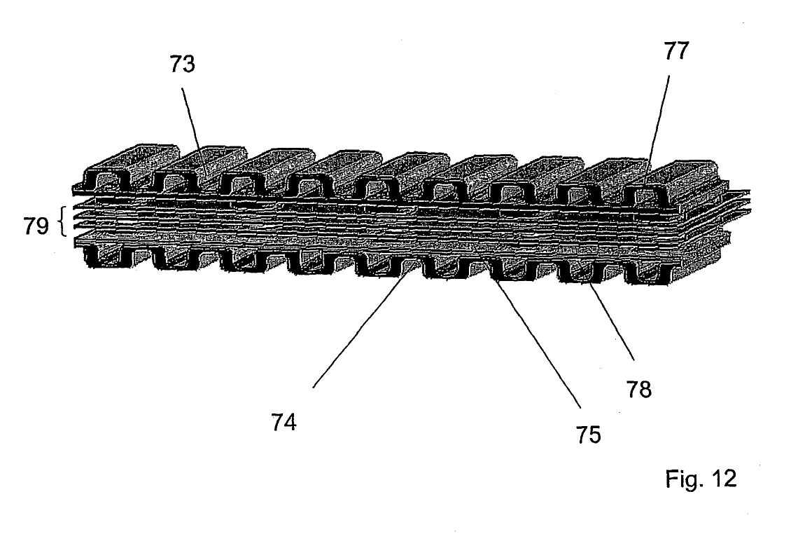

FIG. 12 shows a plate assembly.

The exemplary embodiment according to FIG. 1 comprises two or more plates (1, 2, 5, 6), two of which in each case form a pair (1, 2) and (5, 6). The plate pairs advantageously take the form of communicating half-shells according to DE 102 24 397 A1. Arranged between two such pairs (1, 2) (5, 6), there is a third flow channel having a turbulence insert taking the form of an air cooling flow field (3, 4), which may be supplied with cooling air as a first temperature-adjusting medium, for example by a fan (not shown). A plate assembly is thus prepared from assembled parts 1 to 6, which are connected to one another in fluid-tight manner, for example by welding, soldering or mechanical forming.

In a particularly preferred embodiment, components 1, 2, 5 and 6 are manufactured from stainless steel and welded or soldered to one another. The cooling flow field (3, 4), which may also consist of an individual component, is for example manufactured from aluminum and mechanically positioned after the joining operation for components 1, 2, 5, 6. The plate assembly formed from all the components thus then comprises mutually independent flow channels, for example for cooling air, cooling liquid, anode feed gas and cathode feed gas.

FIG. 2 shows, likewise in an exploded view, an arrangement of a plurality of plate assemblies (7) as a plate stack to form a device for carrying out a chemical reaction. The plate assemblies (7) are here stacked alternately with membranes (8), which are provided with electrodes on both sides.

The plate assemblies, joined together in this illustration, comprise a peripheral seal (9) which comprises discontinuities (10) to form inlet and/or outlet orifices for passage of cooling air as the first temperature-adjusting medium. The first temperature-adjusting medium is thus, outside the plate elements, distributed among/collected from the third flow channels formed by interspaces between two plate elements. For this purpose, a distribution channel and a collection channel (not shown) adjoin the side of the plate stack, which channels communicate with the third flow channels. It is additionally possible, with the assistance of suitable deflecting channels, to provide serpentine flow through the third flow channels, wherein each of the two or more serpentine portions may in turn comprise two or more parallel-connected flow channels, in particular from different plate interspaces. The reaction media and the second temperature-adjusting medium are supplied/removed via distribution and collection channels within the plate stack, for which purpose the individual plates for example comprise rectangular openings.

FIG. 3 shows the qualitative profile of the temperature T of a reaction medium along the length I of a cooling air channel of a known device (11) for carrying out a chemical reaction and of a device according to the invention (12) for carrying out a chemical reaction. It is clear that a more uniform temperature distribution along the cooling air channels can be achieved by an additional liquid cooling circuit. The temperature profile along the cooling air channels is particularly well equalized by the arrangement of fourth flow channels for a liquid cooling medium in each case between the flow channels for the reaction media and the cooling air.

In a further particularly preferred embodiment, a device according to the invention with internal (steam) reforming is used. This is achieved by, instead of cooling air, one of the reactants flowing through the third flow channels and then through the first or second flow channels, the first or second flow channels respectively communicating with the third flow channels, for example via a connecting line or alternatively within the plate stack.

In one more specific embodiment, a zone for the vaporization of the liquid fuel is produced, which zone is functionally upstream of the actual reforming zone, but does not have a catalytic coating in order to achieve vaporization without a chemical reforming reaction. In this particular application, the portions (3, 4) or a corresponding component are at least in part provided with a catalytic coating. In the event that vaporization of liquid fuel components is provided, no catalytic coating is applied in the vaporization zone, which starts at the reformate inlet zone and continues for a suitable extent along a channel.

The proportion of electrically unusable waste heat in the chemically released energy is here obtained from the ratio of the difference of reversible heat tonality [1.48 V] and the electrical cell voltage at the particular operating point for reversible heat tonality. If the reforming process is controlled in such a manner that the quantity of heat necessary for vaporization and/or reforming corresponds to the waste heat, such a system may even be operated autothermally and completely without external coolers.

In one particularly preferred embodiment, the cooling medium used to establish an isothermal state is a fuel/water mixture, which is heated in the zone of the cooling flow field between the plates (1-2) or (5-6) and thereafter steam-reformed in the zone of the reforming flow field (parts 3-4).

In a further preferred embodiment, the fuel/water mixture is kept under pressure, such that it is in liquid form in the zone of the cooling flow field and is depressurized before introduction into the reforming flow field, such that abrupt vaporization occurs here in preparation for the reforming reaction.

In a further preferred embodiment, the operating point or the waste heat of the stack is adjusted such that the energy requirements of the fuel/water mixture heating process in connection with steam reforming are at least partially covered by the waste heat which arises during the chemical reaction, so promoting autothermal operation. This arrangement is in principle suitable for any endothermic or slightly exothermic combination of reactions.

In the context of a catalytically cooled device with internal reforming (for example methanol reforming), the reforming may, under certain circumstances, proceed more efficiently thanks to the virtually isothermal temperature distribution according to the invention over the entire catalytically coated zone.

FIG. 4 shows a fuel cell system cluster 13 with bipolar plates 15 which is for example of the structure according to FIG. 2. Third flow channels 14 in a cooling zone 23 permit passage of cooling air. Thanks to the use of an in particular closed liquid cooling circuit with fourth flow channels, which are not externally visible, the cooling effect of the cooling air can be transferred to adjacent bipolar plates, so that it is not necessary to use every third flow channel for the cooling function. The third flow channels which are, as it were, freed up in this manner may be used for various other tasks in the fuel cell system.

In an evaporation zone 16, water or a water/fuel mixture 18 is vaporized in third channels 17, such that, under certain circumstances, it is possible to dispense with a vaporizer as an independent component acting as a preliminary stage for the reformer.

Partial oxidation, autothermal reforming or steam reforming proceed in a reforming zone 19, wherein the third flow channels 20 located there optionally comprise a suitable catalytic coating of the channel walls with a catalyst suitable for the respective task. Under certain circumstances, it is thus possible to dispense with a reformer as an independent component.

Third flow channels 22 for a water gas shift reaction are provided in a low-temperature shift zone 21, said reaction optionally also being assisted by means of a catalyst. Under certain circumstances, it is thus possible to dispense with a low-temperature shift reactor as an independent component.

The third flow channels of the various zones are connected with one another via suitable connection channels, which are not shown in greater detail, such that the particular fluid, as indicated by arrows 24, 25, passes from one zone into the respective next zone. Similarly, the prepared anode gas, as indicated by the arrows 26, is supplied to an anode gas distribution channel 27. In parallel, cathode gas 28 is supplied to a cathode gas distribution channel 29.

According to embodiments which are not shown, third flow channels are used in certain zones for selective oxidation or anode waste gas combustion. The independent components hitherto provided for this purpose may then in principle be omitted.

According to a further embodiment, the required air is preheated by exposing third flow channels to reaction air for an ATR (“autothermal reforming”) reformer, such that, under certain circumstances, the ATR reaction proceeds more uniformly and a corresponding preheating stage is omitted as an independent component.

According to a further embodiment, the cathode gas is preheated by exposing third flow channels to reaction air for the cathode-side fuel cell process, such that negative temperature effects which occur on introduction of the cathode gas into the fuel cell stack (such as for example electrolyte ageing, condensation, etc.) are reduced or prevented.

According to a further embodiment, desulfurization of the fuel used is enabled by incorporating a suitable transformation catalyst (active desulfurization) or a suitable adsorbent (passive desulfurization) into the third flow channels, for example by coating the walls and/or by introducing a chemically active bulk material, such as for example pellets, tablets etc., and means for preventing entrainment out of the flow channel zone, for example by means of meshes at both ends of the flow channels. This desulfurization may in principle proceed on the fuel in liquid or vapor form before reforming or also on the reformate after reforming. Thanks to the reduction in sulfur content in the reformate achieved in this manner, the deactivation of catalytically active components (for example shift stages) is subsequently reduced or avoided and the service life and efficiency of the fuel cell system are increased.

In one particularly preferred embodiment, the bulk material is replaced with unspent product once a defined minimum activity threshold has been reached. In order to simplify this replacement, the bulk material may be used and optionally easily replaced in the four-inlet bipolar plate in the form of a suitably shaped replacement cartridge.

The precondition for most of the above-stated tasks is a relatively high temperature level, which may conveniently be provided by operating the fuel cell system cluster in conjunction with membrane electrode units using high-temperature polymer electrolyte membranes and exploiting the corresponding nominal operating temperatures (100-200° C.).

A distinction must here be drawn between processes which proceed at cell temperature (for example vaporization, low-temperature shift reaction, cooling) and processes which, while they may start at cell temperature, are usually of an adiabatic nature and proceed at temperatures higher than cell temperature (for example autothermal reforming, partial oxidation, low-temperature shift reaction, selective oxidation, anode waste gas combustion).

In order to be able to have processes of the latter-stated kind proceed for example in a high-temperature polymer electrolyte membrane fuel cell system cluster, it is necessary to permit different temperature levels to develop within the fuel cell system cluster. For this purpose, the catalyst suitable for the respective reaction is preferably arranged on a surface which is thermally decoupled from other flow channels.

According to FIG. 5 and FIG. 6, a catalyst is arranged on a plate element 31 which is thermally decoupled from the other flow channels. Thermal decoupling is here in particular effected by projections 32 on the channel wall of the third flow channel 33, heat flow from the plate element 31 to the channel wall being inhibited by the fact that the plate element 31 is in contact with the channel wall, in particular is soldered to the channel wall, only at points, namely at the tips of the projections. By using the plate element 31, adiabatic reactions are decoupled from the wall temperature of the multifunction flow field, such that reactions may proceed here at higher temperatures.

Alternatively or, as shown in FIG. 7, in addition to an only point-wise contact and depending on the level of the desired temperature, the reaction may be shielded from the cell temperature by using thermal insulation layers 34 on the channel walls of the first, second, third and/or fourth flow channels. Ceramic thermal insulation layers are suitable for this intended application, such as for example aluminum oxide (Al₂O₃), aluminum-titanium oxide (Al₂O₃/TiO₂), zirconium corundum (Al₂O₃/ZrO₂), mullite (Al₂O₃/SiO₂), spinels (Al₂O₃·MgO), zirconium oxide (Mg-ZrO₂), zirconium silicate (ZrSiO₄), etc.

In an embodiment which is not illustrated of a fuel cell system cluster, the fourth flow channels for the liquid coolant are replaced by an analogous structure for development of a heat tube.

In this manner, it is possible to dispense with the use of a pump for circulating the liquid cooling medium, whereby a further saving of installation space and, under certain circumstances, an improvement in system efficiency may optionally be obtained.

The invention makes it possible under certain circumstances to create a simplified system with which the plurality of components necessary in the prior art may be dispensed with and costs and/or installation space may optionally be reduced. In an advantageous embodiment, the device according to the invention combines all the substantial components from FIG. 8 in a single assembly, a fuel cell system cluster. In this manner, the installation space requirement of the fuel cell system is reduced and, under certain circumstances, a cost reduction is achieved. In other developments, system functions are only partially transferred into the fuel cell system cluster, further, functionally independent components remaining in the system.

FIG. 9 shows a cross section through a plate assembly which is arranged between an upper membrane electrode unit (MEU) 41 and a lower MEU 42. First flow channels 43 serve to expose the upper MEU 41 to a cathode gas, while second flow channels 44 serve to expose the lower MEU 42 to an anode gas. Third flow channels 45 serve to convey a first temperature-adjusting medium, for example coolant or cooling air. The first flow channels 43 communicate via openings 46 in an adjacent plate with fourth flow channels, whereby cathode gas may be apportioned along the first flow channels.

FIG. 10 shows a cross section through another plate assembly which is arranged between an upper membrane electrode unit (MEU) 51 and a lower MEU 52. First flow channels 53 serve to expose the upper MEU 51 to a cathode gas, while second flow channels 54 serve to expose the lower MEU 52 to an anode gas. Third flow channels 55 serve to convey a first temperature-adjusting medium, for example cooling air. The first flow channels 53 communicate via aligned openings 56 in two adjacent plates with the third flow channels 55, whereby cathode gas, in particular air or oxygen, may be apportioned along the first flow channels. Fourth flow channels serve to convey a second temperature-adjusting medium, for example liquid coolant.

In a particularly preferred embodiment, some or all of the third flow channels are connected at one end with a source of cathode gas, such as for example a compressor, and are closed at the other end.

FIG. 11 shows a cross section through a plate assembly which is arranged between an upper membrane electrode unit (MEU) 61 and a lower MEU 62. First flow channels 63 serve to expose the upper MEU 61 to a cathode gas, while second flow channels 64 serve to expose the lower MEU 62 to an anode gas. Third flow channels 65 serve to convey a first temperature-adjusting medium, for example coolant or cooling air. The first flow channels 63 communicate via openings 66 in an adjacent plate with fourth flow channels 67, whereby cathode gas, for example reaction air, may be apportioned along the first flow channels. Fifth flow channels 68 serve to convey a third temperature-adjusting medium, for example a liquid coolant or cooling air. In this exemplary embodiment, the third flow channels 65 and/or the fifth flow channels 68 may also be used for vaporization, reaction and the like of the first or third temperature-adjusting medium.

FIG. 12 shows a plate assembly with first flow channels 73 and second flow channels 74. Third flow channels 75 serve to convey a first temperature-adjusting medium, for example coolant or cooling air, while fourth flow channels 77, 78 serve to convey a second temperature-adjusting medium. The third flow channels are subdivided into a plurality of sub-channels by a plurality of plate elements 79 arranged in parallel, which in a particularly preferred embodiment are contoured, for example in the form of a corrugated fin. In this manner, the surface of the third flow channels 75, which is optionally thermally decoupled from the first, second and/or fourth flow channels, is enlarged, for example for an in particular catalytic reaction.

1. A device for carrying out a chemical reaction, in particular for producing electrical energy, comprising at least one first flow channel for a first reaction medium, at least one second flow channel for a second reaction medium which differs from the first reaction medium, at least one third flow channel for a first temperature-adjusting medium and at least one fourth flow channel for a second temperature-adjusting medium which differs from the first temperature-adjusting medium.

2. The device as claimed in claim 1, wherein in each case a plurality of first, second, third and/or fourth flow channels.

3. The device as claimed in claim 1 wherein a fifth flow channel for a third temperature-adjusting medium which differs from the first and the second temperature-adjusting media.

4. The device as claimed in claim 1, wherein at least one first and/or second flow channel is/are connected in communicating manner with at least one third and/or fourth flow channel, in particular via one or more openings in a partition between the first or second flow channel and the third or fourth flow channel.

5. The device as claimed in claim 1, wherein the second temperature-adjusting medium differs from the first temperature-adjusting medium with regard to its thermal capacity or state of matter.

6. The device as claimed in claim 1, wherein the fourth flow channel differs from the third flow channel with regard to the shape or cross-sectional area thereof.

7. The device as claimed in claim 1, wherein the first temperature-adjusting medium is gaseous and in particular comprises or consists of air.

8. The device as claimed in claim 1, wherein the second temperature-adjusting medium is liquid and in particular comprises or consists of water.

9. The device as claimed in claim 1, wherein the first and/or the second reaction medium is gaseous and in particular comprises or consists of hydrogen, oxygen or air.

10. The device as claimed in claim 1, wherein at least one third and/or fourth flow channel comprises a catalyst for a chemical reaction respectively of the first or second temperature-adjusting medium.

11. The device as claimed in claim 1, wherein the catalyst takes the form of a bulk material, in particular powder, granular product, tablets, pellets or the like, or is contained in a bulk material.

12. The device as claimed in claim 1, wherein the catalyst is kept in an in particular replaceable cartridge, which preferably takes the form of a cage for a bulk material.

13. The device as claimed in claim 1, wherein the catalyst is arranged on a surface which is thermally decoupled from other flow channels.

14. The device as claimed in claim 1, wherein the catalyst is arranged on a plate element which is thermally decoupled from other flow channels.

15. The device as claimed in claim 1, wherein the respective channel wall and/or the plate element thermally decoupled from other flow channels comprises projections, wherein the channel wall and the plate element thermally decoupled from other flow channels are in particular only in contact with one another at the projections.

16. The device as claimed in claim 1, wherein the respective channel wall and/or the plate element thermally decoupled from the respective channel wall comprises a thermal insulator which in particular takes the form of a surface coating.

17. The device as claimed in claim 1, wherein the thermally decoupled plate element comprises an in particular catalytically coated honeycomb structure.

18. The device as claimed in claim 1, wherein the thermally decoupled plate element partially or entirely consists of a ceramic material.

19. The device as claimed in claim 1, wherein the thermally decoupled plate element comprises a fiber material, in particular a knit fabric or felt.

20. The device as claimed in claim 1, wherein the thermally decoupled plate element partially or entirely consists of a metal and in particular is connected in electrically conductive manner with at least one channel wall.

21. The device as claimed in claim 1, wherein at least one third and/or fourth flow channel communicates with a first and/or second flow channel.

22. The device as claimed in claim 1, wherein at least one first, second, third and/or fourth distribution and/or collection channel respectively for distributing and collecting the respective medium to/from the first, second, third or fourth flow channels.

23. The device as claimed in 1, wherein the device comprises plate elements, wherein at least one first, second, third and/or fourth flow channel is formed by an interspace between two adjacent plate elements.

24. The device as claimed in claim 1, wherein two adjacent plate elements take the form of half-shells which in particular face towards one another.

25. The device as claimed in claim 1, wherein at least one first, second, third and/or fourth flow channel takes the form of an inwardly embossed portion in a plate element.

26. The device as claimed in claim 1, wherein at least one first, second, third and/or fourth flow channel takes serpentine form.

27. The device as claimed in claim 1, wherein the plate elements comprise openings to form the distribution and/or collection channel(s).

28. The device as claimed in claim 1, wherein at least one distribution and/or collection channel is arranged outside the plate elements and communicates with the interspace between two plate elements.

29. The device as claimed in claim 1, wherein the first and the second flow channel communicate with one another.

30. The device as claimed in claim 1, wherein the first and the second flow channel are separated from one another by at least one in particular diffusion-permeable membrane.

31. The device as claimed in claim 1, wherein plate elements consist of metal or an alloy.

32. The device as claimed in claim 1, wherein at least one first, second, third and/or fourth flow channel comprises at least one surface-enlarging element.

33. The device as claimed in claim 1, wherein at least one surface-enlarging element is formed by a turbulence insert or by an inwardly and/or outwardly embossed wall portion.

34. The device as claimed in claim 1, wherein two adjacent plate elements are peripherally connected to one another in sealing manner, in particular by welding, soldering and/or mechanical forming.

35. The device as claimed in claim 1, wherein a first, second, third and/or fourth flow channel is part of a closed circuit.

36. The device as claimed in claim 1, wherein a first, second, third and/or fourth flow channel is part of a circuit with a fluid conveying device.

37. The device as claimed in claim 1, wherein a fourth flow channel is arranged between a first and/or second flow channel and a third flow channel.

38. The device as claimed in claim 1, wherein at least one plate element comprises at least one indentation, in particular an inwardly embossed portion, to form a first, second, third and/or fourth flow channel.

39. The device as claimed in claim 1, wherein the plate elements are stacked on one another to form a plate stack.

40. The device as claimed in claim 1, wherein in each case a number of, in particular four, plate elements are stacked on one another to form a plate assembly, and that the plate assemblies may be stacked alternately with membranes and/or electrolyte units to form a plate stack.

41. A plate assembly, in particular for forming the device as claimed in claim 1, comprising at least two plate pairs, wherein an interspace between the plate pairs forms at least one third flow channel, and wherein each plate pair comprises two plates, the interspace of which forms a fourth flow channel.
